(19) United States
(12) Patent Application Publication
(10) Pub. No.: US 2026/0110530 A1
(43) Pub. Date: Apr. 23, 2026

(54) WHITE LIGHT INTERFEROMETER AND METHOD OF ADJUSTING INTERFERENCE OPTICAL SYSTEM

(71) Applicant: MITUTOYO CORPORATION, Kanagawa (JP)

(72) Inventor: Yuki KURAHASHI, Tokyo (JP)

(73) Assignee: MITUTOYO CORPORATION, Kanagawa (JP)

(21) Appl. No.: 19/360,306

(22) Filed: Oct. 16, 2025

(30) Foreign Application Priority Data
Oct. 17, 2024 (JP) 2024-182139

(51) Int. Cl. G01B 9/02055; G01B 9/0209

(52) U.S. Cl. CPC G01B 9/0207; G01B 9/0209

(57) ABSTRACT

A white light interferometer includes: an interference optical system; an imaging section that acquires an image of a measurement object; a motion mechanism that moves the interference optical system relative to the measurement object in a height direction; an adjustment mechanism that adjusts an optical path length of a reference light in the interference optical system; a position detector that detects each of a first position and a second position based on images that are acquired by the imaging unit, the first position being a height position of the interference optical system where a luminance value of a target pixel reaches a peak, the second position being a height position of the interference optical system where a contrast value reaches a peak; and an adjustment amount calculator that calculates, based on a deviation amount between the first position and the second position, an adjustment amount of the adjustment mechanism.

### CROSS REFERENCE TO RELATED APPLICATIONS

The entire disclosure of Japanese Patent Application No. 2024-182139 filed Oct. 17, 2024 is expressly incorporated by reference herein.

### TECHNICAL FIELD

The present invention relates to a white light interferometer and a method of adjusting an interference optical system.

### BACKGROUND ART

A white light interferometer using a low-coherence white light is known (see, for instance, Literature 1: JP 2018-096869 A). The white light interferometer includes an interference optical system that causes a measurement light reflected by a measurement surface and a reference light reflected by a reference surface to interfere with each other and an imaging section that captures an image of the measurement surface via the interference optical system. A surface profile of the measurement surface can be measured by causing the interference optical system to move while scanning in a height direction of the measurement surface and analyzing interference fringes appearing in an image.

A typical white light interferometer is designed so that the difference in optical path length between the measurement light and the reference light is close to zero, allowing interference fringes to be observed with high accuracy when the interference optical system is focused on the measurement surface. However, the optical path length of the reference light may deviate due to aging deterioration or temperature changes. For this reason, it is necessary to adjust the optical path length of the reference light in the interference optical system when manufacturing or calibrating the white light interferometer.

However, a known adjustment method involves inclining and positioning a flat measurement surface of a reference object with high accuracy so that interference fringes appear in an image, and then manually fine-tuning the interference optical system while visually checking the interference fringes in the image, which requires a lot of time and effort for the adjustment work. Furthermore, a worker who performs the adjustment is required to have a high level of skill.

### SUMMARY OF THE INVENTION

An object of the invention is to provide a white light interferometer including an easily adjustable interference optical system and a method of adjusting the interference optical system.

A white light interferometer according to an aspect of the invention includes: an interference optical system configured to separate light from a light source into a reference light and a measurement light and cause a returning light of the measurement light from a measurement object and a returning light of the reference light from a reference surface to interfere with each other; an imaging section configured to acquire an image of the measurement object via the interference optical system; a motion mechanism configured to move the interference optical system relative to the measurement object in a height direction; an adjustment mechanism configured to adjust an optical path length of the reference light in the interference optical system; a position detector configured to detect each of a first position and a second position based on a plurality of images that are acquired by the imaging unit and that have mutually different height positions of the interference optical system relative to the measurement object, the first position being a height position of the interference optical system where a luminance value of a target pixel reaches a peak, the second position being a height position of the interference optical system where a contrast value reaches a peak; and an adjustment amount calculator configured to calculate, based on a deviation amount between the first position and the second position, an adjustment amount of the adjustment mechanism.

A method of adjusting an interference optical system in a white light interferometer according to another aspect of the invention, the interference optical system being configured to separate light from a light source into a reference light and a measurement light and cause a returning light of the measurement light from a measurement object and a returning light of the reference light from a reference surface to interfere with each other, the method includes: changing a height position of the interference optical system relative to the measurement object and acquiring a plurality of images of the measurement object via the interference optical system; detecting each of a first position and a second position based on the plurality of images having mutually different height positions of the interference optical system relative to the measurement object, the first position being a height position of the interference optical system where a luminance value of a target pixel reaches a peak, the second position being a height position of the interference optical system where a contrast value reaches a peak; and calculating, based on a deviation amount between the first position and the second position, an adjustment amount of the adjustment mechanism configured to adjust an optical path length of the reference light.

### BRIEF DESCRIPTION OF DRAWINGS

FIG. 1 schematically illustrates a white light interferometer according to an exemplary embodiment of the invention.

FIG. 2 schematically illustrates an interference optical system of the exemplary embodiment.

FIG. 3 is a side view of an appearance of an interference objective lens unit of the exemplary embodiment.

FIG. 4 is a block diagram of a controller of the exemplary embodiment.

FIG. 5 is a flowchart for explaining a method of adjusting the interference optical system of the exemplary embodiment.

FIG. 6 is a graph schematically illustrating a change in luminance value of a target pixel relative to a change in Z position of an optical head of the exemplary embodiment.

FIG. 7 is a graph schematically illustrating a change in contrast value of an image relative to a change in Z position of the optical head of the exemplary embodiment.

FIG. 8 is a graph illustrating exemplary changes in luminance value and in contrast value before adjustment.

FIG. 9 is a graph illustrating exemplary changes in luminance value and in contrast value after adjustment.

### DETAILED DESCRIPTION

Description will be made on an exemplary embodiment of the invention with reference to the drawings.

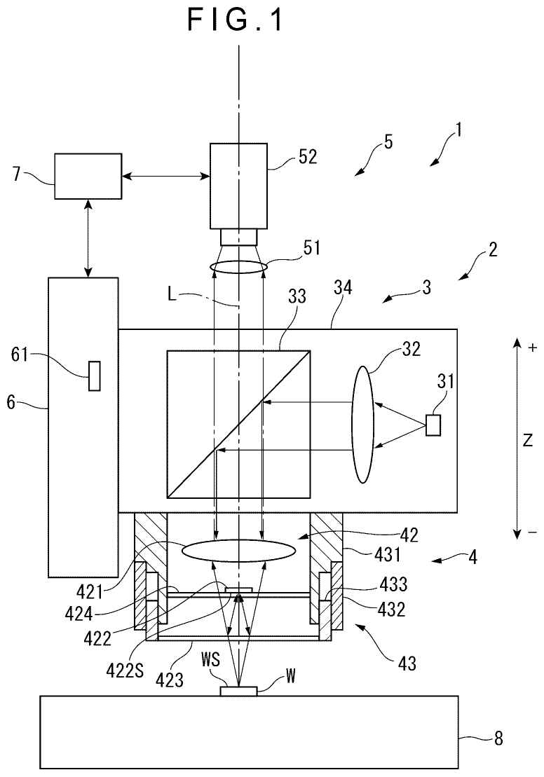

FIG. 1 illustrates a whole structure of a white light interferometer 1 of the exemplary embodiment. The white light interferometer 1 of the exemplary embodiment includes an optical head 2, an imaging unit 5, a motion mechanism 6, a controller 7, and a stage 8.

The optical head 2 includes a head body 3 and an interference objective lens unit 4. The optical head 2 is movable in a Z direction by the motion mechanism 6 described later. In the exemplary embodiment, a height direction of a measurement object W placed on the stage 8 is defined as the Z direction. A direction toward one side in the Z direction is referred to as a +Z direction and a direction toward the opposite side is defined as a-Z direction.

The head body 3 includes a light source 31, a collimating lens 32, a beam splitter 33, and a housing 34.

The light source 31 is a white light source that outputs a low-coherence broadband light. Examples of the light source 31 include halogen and a light emitting diode (LED).

The collimating lens 32 converts the light incident from the light source 31 into parallel light.

The beam splitter 33 reflects the parallel light incident from the collimating lens 32, and the reflected light goes out of the beam splitter 33 to the interference objective lens unit 4. Further, the beam splitter 33 transmits the light incident from the interference objective lens unit 4 therethrough, and the transmitted light go goes out of the beam splitter 33 to the imaging unit 5.

The housing 34 houses the light source 31, the collimating lens 32, and the beam splitter 33. The housing 34 is supported by the motion mechanism 6.

The interference objective lens unit 4 includes an interference optical system 42 and an adjustment mechanism 43 that adjusts a location of an optical element in the interference optical system 42.

The interference optical system 42 of the exemplary embodiment has a so-called Mirau structure. Specifically, the interference optical system 42 includes an objective lens 421, a reference section 422, and a separating/combining section 423, which are arranged on the same optical axis L.

The objective lens 421 includes at least one lens. The objective lens 421 condenses the light incident from the beam splitter 33 onto the measurement object W on the stage 8.

The reference section 422 is disposed between the objective lens 421 and the separating/combining section 423. The reference section 422 includes, for instance, a mirror. The reference section 422 has a reference surface 422S opposed to the measurement object W (that is, facing the-Z direction). The reference section 422 is attached to a center portion of a transparent glass plate 424. The reference section 422 is supported by the adjustment mechanism 43 through the glass plate 424.

The separating/combining section 423 includes, for instance, a beam splitter. The separating/combining section 423 separates the light incident from the objective lens 421 into a reference light Lr reflected by the separating/combining section 423 and a measurement light Lm passing through the separating/combining section 423. The reference light Lr is reflected by the reference surface 422S and then again reflected by the separating/combining section 423. The measurement light Lm is reflected by a surface of the measurement object W (i.e., a measurement surface WS) and then passes, as returning light, through the separating/combining section 423. The separating/combining section 423 thus combines the returning light of the reference light Lr from the reference surface 422S and the returning light of the measurement light Lm from the measurement surface WS.

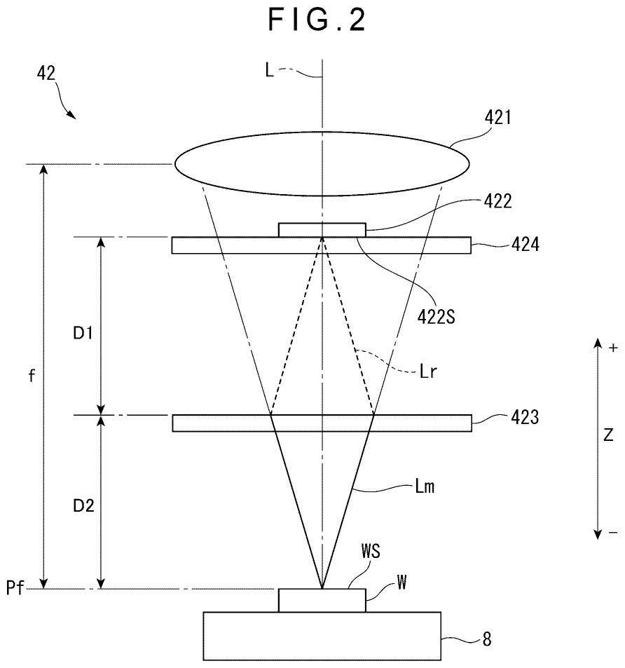

Here, as illustrated in FIG. 2, a distance in the Z direction from a reflective surface of the separating/combining section 423 to the reference surface 422S is defined as a reference distance D1, and a distance from the reflective surface of the separating/combining section 423 to the measurement surface WS is defined as a measurement distance D2. A focal length f of the objective lens 421 is greater than the sum of the reference distance D1 and the measurement distance D2.

An optical path of the reference light Lr in the interference optical system 42 refers to a path for the reference light Lr to travel from the separating/combining section 423 and return via the reference surface 422S to the separating/combining section 423. An optical path of the measurement light Lm in the interference optical system 42 is a path for the measurement light Lm to travel from the separating/combining section 423 and return via the measurement surface WS to the separating/combining section 423. When the reference distance D1 and the measurement distance D2 are equal to each other, the difference in optical path length between the reference light Lr and the measurement light Lm in the interference optical system 42 is zero, resulting in the occurrence of interference in combined light of the reference light Lr and the measurement light Lm.

The adjustment mechanism 43 includes a cylindrical main body 431 attached to the housing 34, a ring-shaped operating section 432 rotatably provided for the main body 431, and a slider 433 supported by the main body 431 to be movable in the Z direction, as illustrated in FIG. 1.

In the exemplary embodiment, the slider 433 is screwed to an inner periphery of the operating section 432. Rotation of the operating section 432 relative to the main body 431 is converted into a motion in the Z direction of the slider 433 relative to the main body 431. That is, the slider 433 moves in the Z direction with respect to the main body 431 according to a rotation direction and a rotation amount of the operating section 432.

Furthermore, in the exemplary embodiment, the main body 431 supports the reference section 422 through the glass plate 424, and the slider 433 supports the separating/combining section 423. As the slider 433 moves in the Z direction with respect to the main body 431, the separating/combining section 423 moves in the Z direction with respect to the reference section 422 to adjust a distance (the reference distance D1 in FIG. 2) between the reference section 422 and the separating/combining section 423.

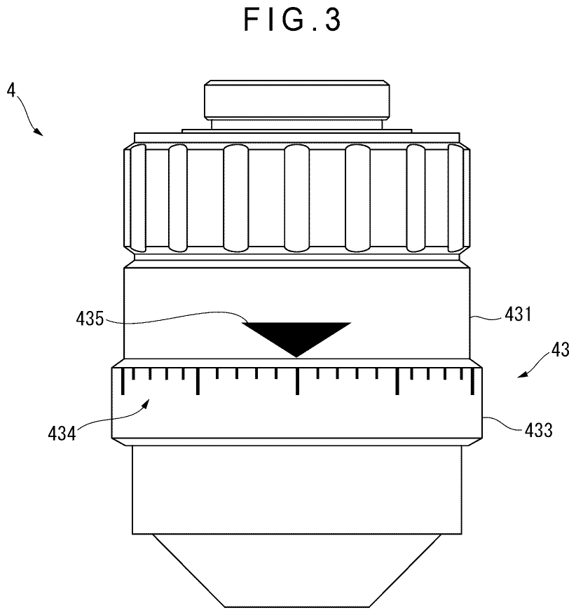

As illustrated in FIG. 3, the operating section 432 displays a scale 434, and the main body 431 displays a mark 435 indicating a reference position. A graduation on the scale 434 indicates an operation amount of the operating section 432, and corresponds to a displacement in the Z direction of the separating/combining section 423.

For instance, in a case where a worker rotates the operating section 432 clockwise by a desired number of graduations, the separating/combining section 423 moves in the −Z direction by a distance corresponding to the number of graduations, which results in an increase in the reference distance D1. In a case where a worker rotates the operating section 432 counterclockwise by a desired number of graduations, the separating/combining section 423 moves in the +Z direction by a distance corresponding to the number of graduations, which results in a decrease in the reference distance D1.

The imaging unit 5 includes an image-forming lens 51 and an imaging section 52, as illustrated in FIG. 1.

The image-forming lens 51 forms, on the imaging section 52, an image of the combined light emitted from the interference objective lens unit 4 and passing through the beam splitter 33.

The imaging section 52 includes, for instance, a charge coupled device (CCD) camera or the like. The imaging section 52 captures an image of the combined light formed by the image-forming lens 51, thus generating an image. The controller 7 receives, as an electric signal, the image outputted from the imaging section 52.

The motion mechanism 6 includes a motor, a linear guide, and the like. The motion mechanism 6 causes the optical head 2 to move in the Z direction based on a motion instruction from the controller 7. That is, the motion mechanism 6 changes a position in the Z direction of the interference optical system 42 relative to the measurement object W on the stage 8.

The motion mechanism 6 also includes a position detecting sensor 61 that detects a position in the Z direction (Z position) of the interference optical system 42. The position detecting sensor 61 includes, for instance, a linear scale. The position detecting sensor 61 outputs the detected Z position of the interference optical system 42 to the controller 7, as appropriate. The Z position of the position detecting sensor 61 corresponds to the Z position of the interference optical system 42.

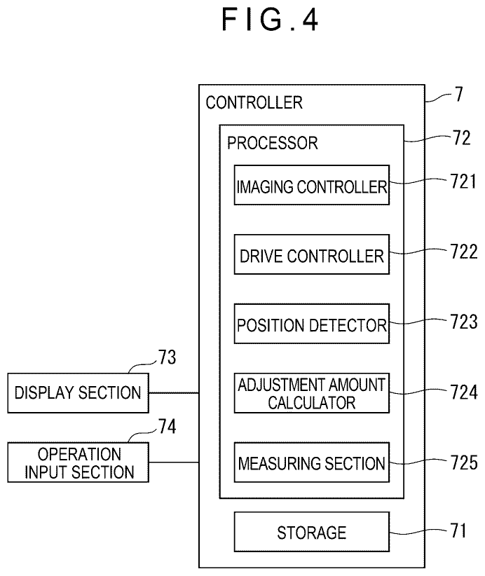

The controller 7 includes a basic configuration of a computer. For instance, as illustrated in FIG. 4, the controller 7 includes a storage 71 including a storage circuit such as a memory and a processor 72 including an arithmetic circuit such as a central processing unit (CPU).

The storage 71 stores a variety of programs including an adjustment program for adjusting the interference optical system 42 and a measurement program for measuring the measurement object W, a variety of data used for executing the variety of programs, and the like.

The storage 71 also stores a table or an arithmetic expression representing a correspondence relationship between a deviation amount ΔP of an optical arrangement of the interference optical system 42 and an adjustment amount of the adjustment mechanism 43 (that is, the operation amount of the operating section 432) for setting the deviation amount ΔP to zero. The deviation amount ΔP of the optical arrangement of the interference optical system 42 may correspond to a deviation amount from an optimal value of the optical path length of the reference light Lr (that is, a deviation amount of the reference distance D1). It is possible to determine the table or the arithmetic expression representing the correspondence relationship between the deviation amount ΔP and the adjustment amount of the adjustment mechanism 43 by an experiment or a simulation performed in advance.

The processor 72 reads and executes the programs stored in the storage 71, functioning as an imaging controller 721, a drive controller 722, a position detector 723, an adjustment amount calculator 724, and a measuring section 725. The details thereabout will be described later.

The white light interferometer 1 further includes a display section 73 and an operation input section 74, which are connected to the controller 7. The display section 73 includes, for instance, a display. The display section 73 outputs a variety of information. The operation input section 74 includes, for instance, a keyboard or a touch panel. The operation input section 74 receives an operation input from a user.

### Adjustment of Interference Optical System

The white light interferometer 1 of the exemplary embodiment is manufactured so that the reference distance D1 is substantially equal to the measurement distance D2 when a focal position Pf of the objective lens 421 coincides with the measurement surface WS, that is, when the imaging section 52 focuses on the measurement surface WS, as illustrated in FIG. 2. However, the difference between the reference distance D1 and the measurement distance D2 may widen due to temperature change or aging deterioration. Thus, in the exemplary embodiment, the interference optical system 42 is adjusted to reduce the difference between the reference distance D1 and the measurement distance D2.

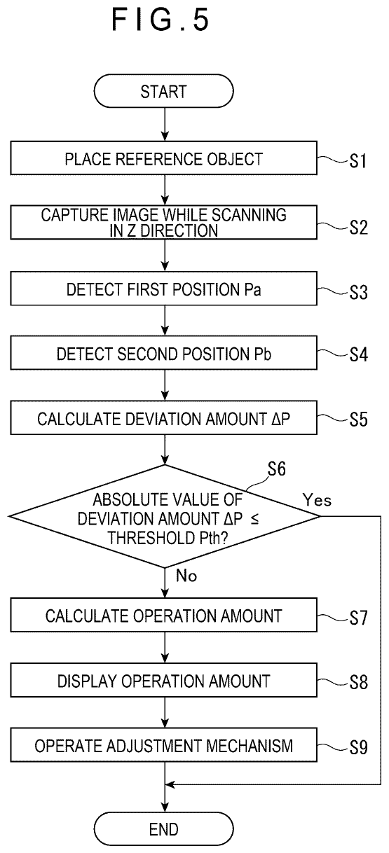

Description will be made below on a method of adjusting the interference optical system 42 of the exemplary embodiment with reference to a flowchart in FIG. 5.

First, a worker places a reference object, which is the measurement object W, on the stage 8 (Step S1). Here, it is only necessary for the reference object to have a flat measurement surface WS. The reference object may have any pattern. The measurement surface WS of the reference object only has to be set substantially vertically with respect to the optical axis L and does not require a high accuracy adjustment for an inclination of the measurement surface WS. Thus, it is assumed that no interference fringe appears in each image acquired in Step S2 described later in the exemplary embodiment.

Next, the motion mechanism 6 causes, under the control of the drive controller 722, the optical head 2 to move along the Z direction from a scanning start position. Then, the imaging section 52 acquires, under the control of the imaging controller 721, an image of the measurement surface WS each time the optical head 2 moves in the Z direction by a predetermined amount (Step S2). In Step S2, a plurality of images that are captured in different Z positions of the optical head 2 relative to the measurement object W are acquired. The controller 7 causes the storage 71 to store each of the images acquired by the imaging section 52 in association with the Z position of the optical head 2 detected by the position detecting sensor 61.

A scanning range in the Z direction of the optical head 2 and the pitch and number of timings of imaging within the scanning range in Step S2 are not particularly limited, as long as it is possible to at least detect a first position Pa and a second position Pb.

The position detector 723 calculates a luminance value Lt of the same target pixel in each image captured in Step S2, and detects, as the first position Pa, the Z position of the optical head 2 where the luminance value Lt reaches a peak (in the exemplary embodiment, when the luminance value Lt has a maximum value) (Step S3).

The target pixel is not particularly limited, and any pixel selected from the image is usable. For instance, a pixel in a center portion of the image is usable as the target pixel.

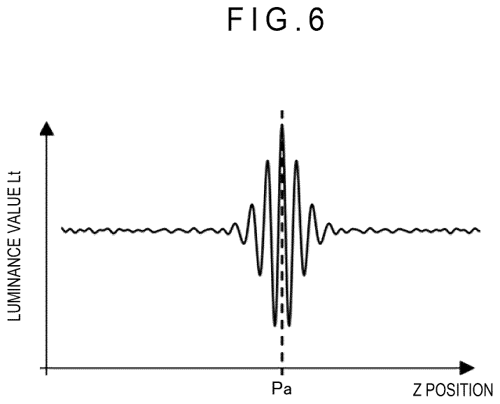

FIG. 6 is a graph schematically illustrating a change in the luminance value Lt of the target pixel relative to a change in the Z position of the optical head 2. In Step S2 described above, the optical head 2 passes through a Z position (hereinafter, referred to as an interference position) where the reference distance D1 is equal to the measurement distance D2 (i.e., the difference in optical path length between the reference light Lr and the measurement light Lm is zero). While the optical head 2 passes in the vicinity of the interference position, light and dark due to interference between the reference light Lr and the measurement light Lm alternately appear in the target pixel, so that the luminance value Lt of the target pixel reaches a plurality of steep peaks (a positive peak and a negative peak) in the vicinity of the interference position. In a case where the Z position of the optical head 2 coincides with the interference position, the luminance value Lt of the target pixel reaches a positive maximum peak.

Thus, in Step S3 described above, the Z position where the luminance value Lt of the target pixel reaches the maximum value is detected as the first position Pa, which corresponds to the interference position.

Furthermore, the position detector 723 calculates a contrast value C of each image captured in Step S2, and detects, as the second position Pb, the Z position of the optical head 2 where the contrast value C reaches a peak (Step S4).

The position detector 723 is capable of calculating the contrast value C based on the luminance value of each pixel in the image. A specific method of calculating the contrast value C is not particularly limited, and a known technique is usable. For instance, with the assumption that out of the luminance values of each pixel in the image, the maximum value is denoted by Imax and the minimum value is denoted by Lmin, the contrast value C may be a Michelson contrast value defined by (Lmax−Lmin)/(Lmax+Lmin) or may be a contrast value ratio defined by a ratio Lmax/Lmin.

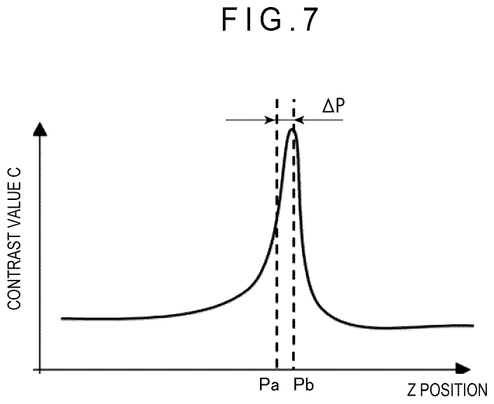

FIG. 7 is a graph schematically illustrating a change in the contrast value C of the image relative to a change in the Z position of the optical head 2. In Step S2 described above, the optical head 2 passes through a Z position (hereinafter, referred to as in-focus position) where the focal position Pf of the objective lens 421 coincides with the measurement surface WS (i.e., the imaging section 52 focuses on the measurement surface WS). The image comes into focus while the optical head 2 is in the in-focus position, which maximizes the contrast value C of the image. Thus, as the optical head 2 passes through the in-focus position, the contrast value C has a single gentle peak.

Accordingly, in Step S4 described above, the Z position where the contrast value C has the peak is detected as the second position Pb, which corresponds to the in-focus position.

The order of Steps S3 and S4 described above is not particularly limited. The luminance value Lt and the contrast value C may be calculated as needed while Step S2 described above is performed.

Subsequently, the adjustment amount calculator 724 calculates the deviation amount ΔP between the first position Pa detected in Step S3 and the second position Pb detected in Step S4 (Step S5). For instance, a value obtained by subtracting the first position Pa from the second position Pb is calculated as the deviation amount ΔP (see FIG. 7) in the exemplary embodiment. The deviation amount ΔP is a value proportional to the difference between the reference distance D1 and the measurement distance D2.

Next, the adjustment amount calculator 724 determines whether or not an absolute value of the deviation amount ΔP calculated in Step S5 is equal to or less than a threshold Pth (Step S6). The threshold Pth is a value set in advance in consideration of an acceptable error.

When it is determined YES in Step S6, the adjustment amount calculator 724 determines that the reference distance D1 is nearly equal to the measurement distance D2, terminating the flowchart in FIG. 5. At this time, the adjustment amount calculator 724 may cause the display section 73 to display a message indicating that no adjustment is necessary.

When it is determined NO in Step S6, the adjustment amount calculator 724 calculates the operation amount of the operating section 432 based on the deviation amount ΔP calculated in Step S5 (Step S7).

Specifically, the adjustment amount calculator 724 uses the table or the arithmetic expression representing the correspondence relationship between the deviation amount ΔP and the operation amount of the operating section 432 to determine the operation amount of the operating section 432 corresponding to the deviation amount ΔP.

Here, the operation amount of the operating section 432 refers to the rotation direction and the rotation amount of the operating section 432 for setting the deviation amount ΔP to zero. The rotation amount of the operating section 432 is indicated by the number of graduations on the scale 434. The rotation direction (clockwise or counterclockwise) of the operating section 432 may be indicated by text or arrow, or may be indicated by a positive/negative indication on the graduation of the scale 434.

Next, the adjustment amount calculator 724 causes the display section 73 to display the operation amount of the operating section 432 calculated in Step S7 described above (Step S8). The worker then operates the operating section 432 in accordance with the operation amount of the operating section 432 displayed on the display section 73 (Step S9). This reduces the difference between the reference distance D1 and the measurement distance D2.

Then, the flowchart in FIG. 5 terminates.

After the above-described adjustment of the interference optical system 42, the worker may replace the reference object, which is the measurement object W, on the stage 8 with a measurement target, and cause the white light interferometer 1 to start the measurement of the measurement target.

For instance, the drive controller 722 and the imaging controller 721 control the motion mechanism 6 and the imaging section 52 as in Step S2 described above. In this configuration, the controller 7 acquires an image each time the optical head 2 moves in the Z direction by the predetermined amount and causes the storage 71 to store the image. The measuring section 725 detects, based on each image stored in the storage 71, the Z position of the optical head 2 where the luminance value of each pixel in the image has the maximum value, and causes the storage 71 to store that Z position as a height of a measurement point. A profile of the measurement target is thus measured.

The measurement after adjusting the interference optical system 42 can inhibit the extension in the Z direction of the height at each measurement point, thus enabling an accurate measurement.

### Workings and Effects of the Exemplary Embodiment

As described above, the white light interferometer 1 of the exemplary embodiment includes: the interference optical system 42 that separates the light from the light source 31 into the reference light Lr and the measurement light Lm and causes the returning light of the measurement light Lm from the measurement object W and the returning light of the reference light (Lr) from the reference surface (422S) to interfere with each other; the imaging section 52 that acquires an image of the measurement object W via the interference optical system 42; the motion mechanism 6 that moves the interference optical system 42 relative to the measurement object W in the height direction (Z direction); the adjustment mechanism 43 that adjusts the optical path length of the reference light Lr in the interference optical system 42; the position detector 723 that detects each of the first position Pa and the second position Pb based on a plurality of images that are acquired by the imaging section 52 and that have mutually different height positions (Z positions) of the interference optical system 42 relative to the measurement object W, the first position Pa being a height position (Z position) of the interference optical system 42 where the luminance value Lt of a target pixel reaches a peak, the second position Pb being a height position (Z position) of the interference optical system 42 where the contrast value C reaches a peak; and the adjustment amount calculator 724 that calculates, based on the deviation amount ΔP between the first position Pa and the second position Pb, the adjustment amount of the adjustment mechanism 43.

It is possible for such a configuration to detect, as the first position Pa, a height position of the interference optical system 42 where the difference in optical path length between the reference light Lr and the measurement light Lm is zero and to detect, as the second position Pb, a height position of the interference optical system 42 where the interference optical system 42 is focused on the measurement surface WS of the measurement object W. Since the deviation amount ΔP between the first position Pa and the second position Pb corresponds to a deviation amount from the optimal value of the optical path length of the reference light Lr (i.e., the deviation amount from the optimal value of the reference distance D1), the adjustment amount of the adjustment mechanism 43 for reducing the deviation amount of the reference distance D1 can be calculated based on the deviation amount ΔP between the first position Pa and the second position Pb. Thus, in adjusting the interference optical system 42, it is only necessary to operate the adjustment mechanism 43 in accordance with the calculated adjustment amount without the necessity of visually checking interference fringes in the image. This reduces the effort and time required for the adjustment work, and a worker performing the adjustment does not need to have advanced skills. That is, the interference optical system 42 in the white light interferometer 1 of the exemplary embodiment is easily adjustable.

In the exemplary embodiment, the adjustment mechanism 43 includes the operating section 432 that receives an operation for adjusting the optical path length of the reference light Lr, and the adjustment amount calculator 724 calculates, as the adjustment amount of the adjustment mechanism 43, the operation amount of the operating section 432.

Such a configuration makes it easy for a worker to manually adjust the interference optical system 42.

In the exemplary embodiment, the adjustment mechanism 43 further includes the scale 434 for measuring the operation amount of the operating section 432, and the operation amount of the operating section 432 is indicated by the number of graduations on the scale 434.

Such a configuration further makes it easy for a worker to manually adjust the interference optical system 42.

The method of adjusting the interference optical system 42 of the exemplary embodiment includes: Step S2 of changing the height position of the interference optical system 42 relative to the measurement object W in the above-described white light interferometer 1 and acquiring a plurality of images of the measurement object W via the interference optical system 42; Steps S3 and S4 of detecting each of the first position Pa and the second position Pb based on the plurality of images having mutually different height positions of the interference optical system 42 relative to the measurement object W, the first position Pa being a height position (Z position) of the interference optical system 42 where the luminance value Lt of a target pixel reaches a peak, the second position Pb being a height position (Z position) of the interference optical system 42 where the contrast value C reaches a peak; and Steps S5 and S7 of calculating the adjustment amount of the adjustment mechanism 43 based on the deviation amount ΔP between the first position Pa and the second position Pb.

Such a method produces effects similar to those of the above-described white light interferometer 1 described above.

### Modifications

The invention is not limited to the above-described exemplary embodiment and modifications and the like are within the scope of the invention as long as the object of the invention is achievable.

### Modification 1

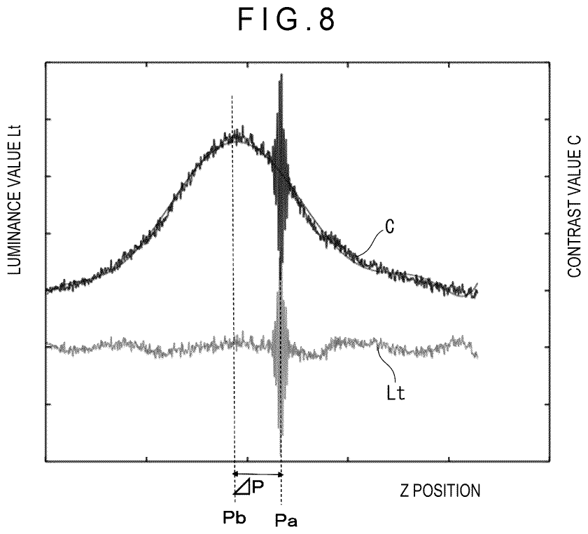

In the above-described exemplary embodiment, the description is made on the case where no interference fringe appears in each image acquired in above-described Step S2. Interference fringes, however, may appear in the image. It should be noted that in such a case, when the optical head 2 is positioned in the vicinity of the interference position, the contrast value C of the image reaches a plurality of steep peaks, as illustrated in FIG. 8, similarly as the luminance value Lt of the target pixel. Thus, in above-described Step S4, the position detector 723 may use a known technique such as computation using differentiation or filtering to calculate a trend of a change in the contrast value C relative to a change in the Z position of the optical head 2, and detect, as the second position Pb, the Z position of the optical head 2 where the trend of the contrast value C reaches a peak. This makes it possible to appropriately detect the second position Pb irrespective of whether or not interference fringes appear.

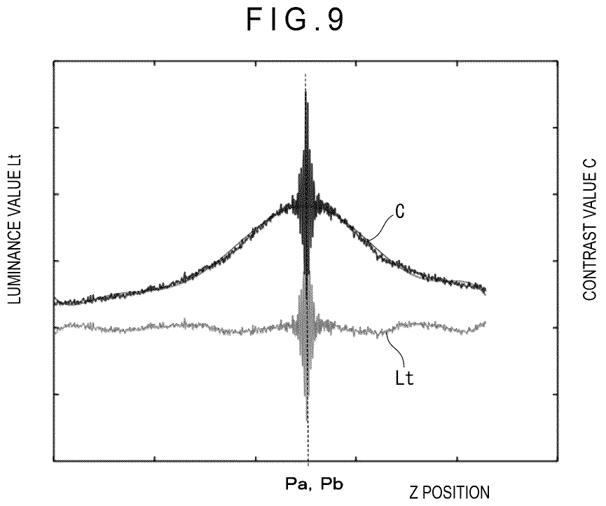

If interference fringes appear in the image, after adjusting the interference optical system 42, a graph like that illustrated in FIG. 9 can be obtained. In FIG. 9, the Z position where the luminance value Lt of the target pixel reaches a positive peak coincides with the Z position where the trend of the contrast value C reaches a peak, so that the difference in optical path length between the reference light Lr and the measurement light Lm when the interference optical system 42 is focused on the measurement surface WS is zero.

### Modification 2

The position detector 723 detects, as the first position Pa, the Z position of the optical head 2 where the luminance value Lt reaches a positive maximum peak in above-described Step S3. The invention, however, is not limited thereto. For instance, the Z position of the optical head 2 where the luminance value Lt reaches a negative maximum peak may be detected as the first position Pa, as long as an accuracy issue is acceptable. Alternatively, the Z position of the optical head 2 corresponding to any one of a plurality of peaks (a positive peak and a negative peak) reached by the luminance value Lt of the target pixel in the vicinity of the interference position may be detected as the first position Pa.

Modification 3 In the above-described exemplary embodiment, the description is made on the case where a worker manually adjusts the interference optical system 42. The invention, however, is not limited thereto. That is, the white light interferometer 1 may include a driver such as a motor that drives the operating section 432 to automatically adjust the interference optical system 42. In this case, the adjustment amount calculator 724 may calculate, as the adjustment amount of the adjustment mechanism 43, a control amount of the driver that drives the operating section 432 in above-described Step S8. Furthermore, the controller 7 may control the driver based on the calculated control amount in above-described Step S9.

### Modification 4

In the above-described exemplary embodiment, the description is made on the case where the adjustment mechanism 43 adjusts the Z position of the separating/combining section 423. The invention, however, is not limited thereto. That is, the adjustment mechanism 43 may adjust the reference section 422 in the Z direction. Specifically, the adjustment mechanism 43 may include the main body 431 supporting the separating/combining section 423 and the slider 433 supporting the reference section 422 through the glass plate 424. In such a modification, as the slider 433 moves in the Z direction with respect to the main body 431, the reference section 422 moves in the Z direction with respect to the separating/combining section 423 to adjust a distance (the reference distance D1 in FIG. 2) between the reference section 422 and the separating/combining section 423.

### Modification 5

The motion mechanism 6 of the above-described exemplary embodiment causes the interference optical system 42 to move relative to the measurement surface WS by causing the optical head 2 to move in the Z direction. The invention, however, is not limited thereto. For instance, the white light interferometer 1 of the above-described exemplary embodiment may include a motion mechanism that drives the stage 8 in place of the motion mechanism 6 that causes the optical head 2 to move in the Z direction.

### Modification 6

The interference objective lens unit 4 has a Mirau structure in the above-described exemplary embodiment. The interference objective lens unit 4 may, however, have a Michelson structure. In this case, the adjustment mechanism 43 is capable of adjusting the optical path length of the reference light Lr by adjusting a position of the reference section 422 along an optical axis of the reference light Lr.

What is claimed is

1. A white light interferometer, comprising:
an interference optical system configured to separate light from a light source into a reference light and a measurement light and cause a returning light of the measurement light from a measurement object and a returning light of the reference light from a reference surface to interfere with each other;
an imaging section configured to acquire an image of the measurement object via the interference optical system;
a motion mechanism configured to move the interference optical system relative to the measurement object in a height direction;
an adjustment mechanism configured to adjust an optical path length of the reference light in the interference optical system;
a position detector configured to detect each of a first position and a second position based on a plurality of images that are acquired by the imaging unit and that have mutually different height positions of the interference optical system relative to the measurement object, the first position being a height position of the interference optical system where a luminance value of a target pixel reaches a peak, the second position being a height position of the interference optical system where a contrast value reaches a peak; and
an adjustment amount calculator configured to calculate, based on a deviation amount between the first position and the second position, an adjustment amount of the adjustment mechanism.

2. The white light interferometer according to claim 1, wherein the position detector is configured to calculate a trend of a change in the contrast value relative to a change in the height position of the interference optical system, and detect, as the second position, a height position of the interference optical system where the trend of the contrast value reaches a peak.

3. The white light interferometer according to claim 1, wherein
the adjustment mechanism includes an operating section configured to receive an operation for adjusting the optical path length of the reference light, and
the adjustment amount calculator is configured to calculate, as the adjustment amount of the adjustment mechanism, an operation amount of the operating section.

4. The white light interferometer according to claim 3, wherein
the adjustment mechanism further includes a scale with which the operation amount of the operating section is measured, and
the operation amount of the operating section is indicated by the number of graduations on the scale.

5. A method of adjusting an interference optical system in a white light interferometer, the interference optical system being configured to separate light from a light source into a reference light and a measurement light and cause a returning light of the measurement light from a measurement object and a returning light of the reference light from a reference surface to interfere with each other, the method comprising:
changing a height position of the interference optical system relative to the measurement object and acquiring a plurality of images of the measurement object via the interference optical system;
detecting each of a first position and a second position based on the plurality of images having mutually different height positions of the interference optical system relative to the measurement object, the first position being a height position of the interference optical system where a luminance value of a target pixel reaches a peak, the second position being a height position of the interference optical system where a contrast value reaches a peak; and
calculating, based on a deviation amount between the first position and the second position, an adjustment amount of the adjustment mechanism configured to adjust an optical path length of the reference light.
